(19) United States
(12) Patent Application Publication
(10) Pub. No.: US 2012/0274507 A1
(43) Pub. Date: Nov. 1, 2012

(54) ARCHITECTURE AND METHOD FOR OPTIMAL TRACKING OF MULTIPLE BROADBAND SATELLITE TERMINALS IN SUPPORT OF IN THEATRE AND RAPID DEPLOYMENT APPLICATIONS

(76) Inventors: Jaafar Cherkaoui, Dollard-Des-Ormeaux (CA); Peter Takats, Baie D'Urfe (CA); Stuart Taylor, Westmount (CA); Peter Garland, Beaconsfield (CA); Luigi Pozzebon, Ville De Lorraine (CA)

(21) Appl. No.: 13/456,971

(22) Filed: Apr. 26, 2012

Related U.S. Application Data
(60) Provisional application No. 61/457,599, filed on Apr. 28, 2011.

(51) Int. Cl. H04B 7/185

(52) U.S. Cl. 342/354

(57) ABSTRACT

An antenna communication architecture for simultaneous optimal tracking of multiple broadband satellite terminals in support of in theatre operations and rapid deployment applications, and methods in relation therewith. This communication architecture is especially suitable for implementation as a hosted payload configuration on a host spacecraft.

### CROSS-REFERENCE TO RELATED APPLICATIONS

This application claims priority of U.S. Provisional Application for Patent No. 61/457,599 filed Apr. 28, 2011, the content of which is incorporated herein by reference in its entirety.

### FIELD OF THE INVENTION

The present invention relates to the field of antenna systems and satellite applications, and is more particularly concerned with an architecture for simultaneous optimal tracking of multiple broadband satellite terminals in support of in theatre operations and rapid deployment applications, and methods in relation therewith.

### BACKGROUND OF THE INVENTION

It is well known in the art to use communication satellites with large and shaped beam coverage antenna systems, as described in different patent related documents such as U.S. Pat. No. 5,754,138 granted to Turcotte et al., U.S. Pat. No. 5,856,804 granted to Turcotte et al., U.S. Pat. No. 6,684,071 granted to Molnar et al., U.S. Pat. No. 6,895,217 granted to Chang et al., US Patent Publication No. US 2010/0302971 A1 of Walker et al.

These antennas typically have multiple beams to cover a specific region on the earth surface and require a relatively large reflector as well as a low communication bit rate to ensure a good performance, also considering interference mitigation between adjacent beams. In addition, these antennas are also typically static (fixed on the spacecraft or satellite), and, depending on the communication RF (Radio-Frequency) frequency band, use either a relatively large antenna aperture (up to about twenty meters (20 m)) for low frequencies such as L-band, or a plurality of smaller antenna apertures (in the order of about one and half meter (1.5 m)) for high frequencies such as Ku-band and Ka-band.

Furthermore, the covered region on the earth surface is so large, the United States of America for example, that the communication traffic is highly variable from beam to beam, thus leading to only a few beams having most of the traffic. Such operation conditions force the overall design of these antenna systems to be complex when they could have been much simpler and less expensive if designed only for those few high traffic beams.

Accordingly, these antenna systems require a significant amount of hardware on the spacecraft, including tens of feeds and corresponding waveguides, which leads to relatively long development, performed in parallel and along with the overall design of the spacecraft, the length of which depends on the specific mission and/or operations thereof. In view of their hardware complexity, such antenna systems are not suitable for applications that in other respects can be supported by a hosted payload configuration. Hosted Payloads are a relatively new trend in the satellite industry that requires a, typically rapidly customizable, design to fit the available accommodation on the host satellite.

In view of the complexities of these wide area coverage systems, there is a need for an improved architecture featuring optimal tracking of multiple broadband satellite terminals to support of in theatre and rapid deployment applications, combined with associated design methods relevant to a small or hosted payload.

### SUMMARY OF THE INVENTION

It is therefore a general object of the present invention to provide an improved architecture for optimal tracking of multiple broadband satellite terminals in support of in theatre and rapid deployment applications, and methods in relation therewith.

An advantage of the present invention is that the architecture is capable of relatively high bit rate communication to the individual terminals with a substantially broadband RF signal frequency range.

Another advantage of the present invention is that the architecture requires a single relatively small antenna reflector for the in theatre user coverage.

A further advantage of the present invention is that the antenna reflector of the communication architecture is steerable in order to select the desired coverage and position of the theatre on the ground surface. This is mandatory for emergency applications or operations that require to redirect the antenna to the theatre of operation over a region dealing with a natural disaster or a political, instability situation or the like. This effectively creates coverage on demand.

Still another advantage of the present invention is that the communication architecture is particularly well adapted to a hosted payload, permitting rapid deployment that is especially well suited for different types of applications or operations (requiring relatively short lead design and implementation time).

Yet another advantage of the present invention is that the communication architecture is well suited for coverage regions of non-uniform traffic, with the satellite coverage capable of being positioned only over high traffic zones if desired, and occasionally over other regions.

Still a further advantage of the present invention is that the communication architecture can support different types of carrier access scheme, whether Time Division Multiple Access (TDMA), Frequency Division Multiple Access (FDMA), Code Division Multiple Access (CDMA) or some combination thereof, and to different types of networking connections, whether star or mesh.

Yet a further advantage of the present invention is that the communication architecture, when having its signal beams generated using an agile beam forming technology, allows for cancellation of traffic jamming and interference signals for enhanced terminal communication and tracking, allows the whole of the available user frequency band is available over the complete coverage theatre area with the maximum number of beams being proportional to the availability of capacity in the system, and eliminates the frequency handover between beam clusters since each moving ground target terminal is tracked by a same beam over the entire operational area.

According to an aspect of the present invention there is provided an architecture for optimal tracking of multiple broadband satellite terminals in support of in theatre and rapid deployment applications, said architecture comprising:
an antenna system having a feed array fixedly mounted on an antenna structure and operably connected to a reflector movably mounted on the antenna structure for transmitting and receiving at least one electromagnetic signal to and from the movable theatre of operation defined on a ground surface, the feed array generating a plurality of signal beams within the theater for a tracking of said at least one electromagnetic signal corresponding to a respective satellite terminal; and
a signal feeder link assembly connecting to the feed array for communication of said at least one electromagnetic signal of said signal beams to a ground gateway.

In one embodiment, the plurality of signal beams are generated using an agile beam forming technology.

In one embodiment, each said signal beam tracks a corresponding one of said at least one electromagnetic signal corresponding to a respective satellite terminal.

In one embodiment, the plurality of signal beams are substantially adjacent from one another.

Conveniently, the at least one said plurality of signal beams is centered over said at least one electromagnetic signal corresponding said respective satellite terminal being tracked.

Typically, the plurality of signal beams is optimized for a link performance providing for a traffic jamming/interference cancellation around the at least one electromagnetic signal corresponding said respective satellite terminal being tracked.

In one embodiment, the ground gateway is movable on the ground surface.

According to another aspect of the present invention there is provided a spacecraft comprising:
an antenna structure;
an architecture for optimal tracking of multiple broadband satellite terminals in support of in theatre and rapid deployment applications, the architecture comprising:
an antenna system having a feed array fixedly mounted on the antenna structure and operably connected to a reflector movably mounted on the antenna structure for transmitting and receiving at least one electromagnetic signal to and from the movable theatre of operation defined on a ground surface, the feed array generating a plurality of signal beams within the theater for a tracking of said at least one electromagnetic signal corresponding to a respective satellite terminal; and
a signal feeder link assembly connecting to the feed array for communication of said at least one electromagnetic signal of said signal beams to a ground gateway.

According to another aspect of the present invention there is provided a method for optimal tracking of multiple moving broadband satellite terminals in support of in theatre operations and rapid deployment applications, said method comprising the steps of:
steering a reflector of an antenna system toward a selected theatre of operation defined on a ground surface;
providing for a plurality of signal beams within the theater for tracking at least one electromagnetic signal corresponding to a respective satellite terminal;
communicating said at least one electromagnetic signal of the signal beams to a ground gateway via a signal feeder link assembly connected to a feed array of the antenna system.

In one embodiment, the step of providing for a plurality of signal beams includes generating said plurality of signal beams using an agile beam forming technology.

Conveniently, the step of generating said plurality of signal beams using an agile beam forming technology includes generating said plurality of signal beams using a ground based beam forming process.

Typically, the step of generating said plurality of signal beams includes optimizing a link performance of each said plurality of signal beams for the tracking of said at least one electromagnetic signal corresponding to a respective satellite terminal.

Conveniently, the step of optimizing a link performance includes performing a traffic jamming/interference cancellation around the at least one electromagnetic signal corresponding said respective satellite terminal being tracked.

Alternatively, the step of optimizing a link performance includes centering at least one said plurality of signal beams over said at least one electromagnetic signal corresponding said respective satellite terminal being tracked.

Conveniently, the step of generating said plurality of signal beams using an agile beam forming technology further includes transmitting said signal beams to the antenna system via the signal feeder link assembly.

Typically, the step of generating said plurality of signal beams using an agile beam forming technology includes allocating at least one said signal beam to a respective satellite terminal.

In one embodiment, the method further includes the step of interfacing with a ground network hub linked to at least one traffic user via the ground gateway so as to transfer a corresponding said at least one electromagnetic signal therewith.

Conveniently, the step of generating said plurality of signal beams using an agile beam forming technology further includes generating said plurality of signal beams at least partially using an on-board beam forming process.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a schematic diagram of an embodiment of an RF communication architecture for simultaneous optimal tracking of multiple broadband satellite terminals in support of in theatre operations and rapid deployment applications, in accordance with the present invention; and

FIG. 2 is a flowchart diagram of an embodiment of a method of an RF communication architecture for simultaneous optimal tracking of multiple broadband satellite terminals in support of in theatre operations and rapid deployment applications, in accordance with the present invention.

### DETAILED DESCRIPTION OF THE INVENTION

With reference to the annexed drawings the preferred embodiment of the present invention will be herein described for indicative purpose and by no means as of limitation.

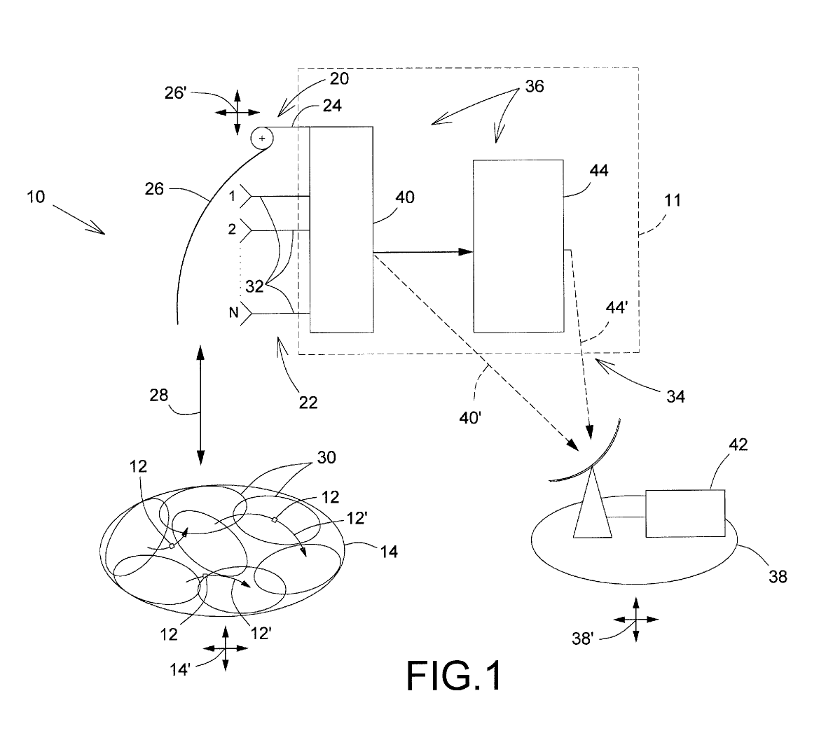

Referring to FIG. 1, there is shown a schematic diagram of an embodiment 10 of an RF communication architecture for optimal tracking of multiple moving (as depicted by arrows 12′) broadband satellite terminals 12 in support of in theatre 14 operations and rapid deployment applications, in accordance with the present invention.

The architecture 10 includes a spacecraft antenna system 20 having a feed array 22 fixedly mounted on an antenna structure 24 of a spacecraft 11 or the like and operably connected to a reflector 26 movably, as depicted by arrow 26′, mounted on the antenna structure 24 for transmitting and receiving at least one electromagnetic signal 28 to and from the movable (as depicted by arrows 14′) theatre 14 of operation defined on a ground surface (the Earth surface—not shown). The feed array 22, including N feeds 32, and typically seven (7), generates a plurality of corresponding element beams 30 substantially adjacent from one another within the theater 14 for the tracking of each electromagnetic signal(s) 28 corresponding to a respective satellite terminal 12. The formed beams 30, or ground spots, clusters or cells, are typically slightly overlapping one another, although they could be also spaced from one another without departing from the scope of the present invention, and are typically generated using an agile beam forming technology 34 that also provides for the traffic jamming/interference cancellation around the terminals 12 being tracked. A signal feeder link assembly 36 connects to the feed array 22 for communication of the electromagnetic signal(s) 28 of the signal beams 30 to a ground gateway 38 that could also be mobile (as depicted by arrow 38′) on the ground surface.

As seen in FIG. 1, each satellite terminal 12, that could be fixed or mobile on the ground surface, or nearby (as a flying vehicle or aircraft), may cross over more than one beam 30 when moving, or even move in-between two adjacent beams, without compromising RF communication therewith. The quantity of terminals 12 that can be simultaneously tracked typically depends on the frequency bandwidth of the antenna system 20 and the carrier per user, the larger the bandwidth the larger the number of simultaneous live terminals.

The signal feeder link assembly 36 typically includes a multiple uplink signal acquisition 40 connected to the feed array 22 and communicating with the ground based gateway 38 via a gateway beam, as represented by arrow 40′, where extensive agile ground based beam forming (GBBF) 42 of the agile beam forming technology 34 is performed for the optimized link performance for the multiple moving terminals 12, along with jamming/interference signal cancellation for enhanced performance of the communication architecture 10. With the agile beam forming technology, each signal beam 30 is typically generated in such a way to be generally centered over a corresponding satellite terminal 12.

Optionally, whenever required depending on the type of operation and/or application, a portion of the beam forming can be performed on-board of the spacecraft (or satellite) by the signal feeder link assembly 36 via an agile on-board beam forming (OBBF) 44 connected to the multiple uplink signal acquisition 40 and communicating with the ground based gateway 38 as a link for hybrid OBBF and GBBF gateway beam, as represented by arrow 44. This hybrid OBBF and GBBF increases the capabilities of the present communication architecture 10 towards the networking connection, whether star or mesh, and/or the type of carrier multiple access scheme, whether TDMA, FDMA, CDMA or some combination thereof.

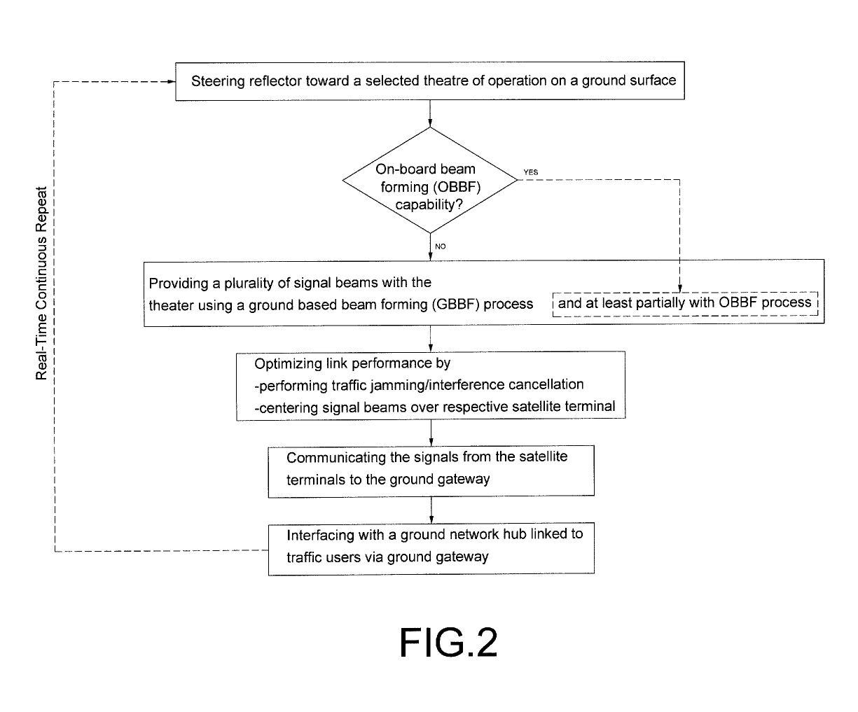

Accordingly, as illustrated in FIG. 2, the present invention also refers to a method for optimal tracking of multiple moving broadband satellite terminals 12 in support of in theatre 14 operations and rapid deployment applications. The method comprising the general steps of
steering a reflector of an antenna system toward a selected theatre 14 of operation defined on a ground surface;
providing for a plurality of signal beams 30 substantially adjacent from one another within the theater 14 for tracking at least one electromagnetic signal 28 corresponding to a respective satellite terminal 12 using an agile beam forming technology 34;
communicating the electromagnetic signal(s) 28 of the signal beams 30 to a ground gateway 38 on the ground surface via a signal feeder link assembly 36 connected to a feed array 22 of the antenna system 20.

Also, the present invention provides for a method of flexibly forming, allocating and steering the signal beams within the theatre coverage according to, but not limited to, the following operating parameters:
plurality of satellite terminal requests for connections;
the near real-time location of the satellite terminals;
the amount of bandwidth allocated;
type of carrier access scheme, whether TDMA, FDMA, CDMA or some combination thereof;
type of networking connection, whether star or mesh; and
the duration of the connections.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

We claim:

1. An architecture for optimal tracking of multiple broadband satellite terminals in support of in theatre and rapid deployment applications, said architecture comprising:
an antenna system having a feed array fixedly mounted on an antenna structure and operably connected to a reflector movably mounted on the antenna structure for transmitting and receiving at least one electromagnetic signal to and from the movable theatre of operation defined on a ground surface, the feed array generating a plurality of signal beams within the theater for a tracking of said at least one electromagnetic signal corresponding to a respective satellite terminal; and
a signal feeder link assembly connecting to the feed array for communication of said at least one electromagnetic signal of said signal beams to a ground gateway.

2. The architecture of claim 1, wherein the plurality of signal beams are generated using an agile beam forming technology.

3. The architecture of claim 1, wherein each said signal beam tracks a corresponding one of said at least one electromagnetic signal corresponding to a respective satellite terminal.

4. The architecture of claim 1, wherein the plurality of signal beams are substantially adjacent from one another.

5. The architecture of claim 2, wherein at least one said plurality of signal beams is centered over said at least one electromagnetic signal corresponding said respective satellite terminal being tracked.

6. The architecture of claim 2, wherein said plurality of signal beams is optimized for a link performance providing for a traffic jamming/interference cancellation around the at least one electromagnetic signal corresponding said respective satellite terminal being tracked.

7. The architecture of claim 1, wherein said ground gateway is movable on the ground surface.

8. A spacecraft comprising:
an antenna structure;
an architecture for optimal tracking of multiple broadband satellite terminals in support of in theatre and rapid deployment applications, said architecture comprising:
an antenna system having a feed array fixedly mounted on the antenna structure and operably connected to a reflector movably mounted on the antenna structure for transmitting and receiving at least one electromagnetic signal to and from the movable theatre of operation defined on a ground surface, the feed array generating a plurality of signal beams within the theater for a tracking of said at least one electromagnetic signal corresponding to a respective satellite terminal; and
a signal feeder link assembly connecting to the feed array for communication of said at least one electromagnetic signal of said signal beams to a ground gateway.

9. A method for optimal tracking of multiple moving broadband satellite terminals in support of in theatre operations and rapid deployment applications, said method comprising the steps of:
steering a reflector of an antenna system mounted on a spacecraft toward a selected theatre of operation defined on a ground surface;
providing for a plurality of signal beams within the theater for tracking at least one electromagnetic signal corresponding to a respective satellite terminal;
communicating said at least one electromagnetic signal of the signal beams to a ground gateway via a signal feeder link assembly connected to a feed array of the antenna system.

10. The method of claim 9, wherein the step of providing for a plurality of signal beams includes generating said plurality of signal beams using an agile beam forming technology.

11. The method of claim 10, wherein the step of generating said plurality of signal beams using an agile beam forming technology includes generating said plurality of signal beams using a ground based beam forming process.

12. The method of claim 11, wherein the step of generating said plurality of signal beams includes optimizing a link performance of each said plurality of signal beams for the tracking of said at least one electromagnetic signal corresponding to a respective satellite terminal.

13. The method of claim 12, wherein the step of optimizing a link performance includes performing a traffic jamming/interference cancellation around the at least one electromagnetic signal corresponding said respective satellite terminal being tracked.

14. The method of claim 12, wherein the step of optimizing a link performance includes centering at least one said plurality of signal beams over said at least one electromagnetic signal corresponding said respective satellite terminal being tracked.

15. The method of claim 11, wherein the step of generating said plurality of signal beams using an agile beam forming technology further includes transmitting said signal beams to the antenna system via the signal feeder link assembly.

16. The method of claim 10, wherein the step of generating said plurality of signal beams using an agile beam forming technology includes allocating at least one said signal beam to a respective satellite terminal.

17. The method of claim 9, further including the step of interfacing with a ground network hub linked to at least one traffic user via the ground gateway so as to transfer a corresponding said at least one electromagnetic signal therewith.

18. The method of claim 11, wherein the step of generating said plurality of signal beams using an agile beam forming technology further includes generating said plurality of signal beams at least partially using an on-board beam forming process.
